(19) United States
(12) Patent Application Publication
(10) Pub. No.: US 2026/0254311 A1
(43) Pub. Date: Aug. 27, 2026

(54) DRIVE UNIT FOR A MOTOR VEHICLE, IN PARTICULAR FOR A CAR, AND MOTOR VEHICLE

(71) Applicants: Bayerische Motoren Werke Aktiengesellschaft, München (DE); Schunk Carbon Technology GmbH, Goisern am Hallst¿ttersee (AT)

(72) Inventors: Peter FOESSL, Behamberg (AT); Jürgen FREISMUTH, Altaussee (AT); Hermann WATZINGER, Ebensee am Traunsee (AT)

(21) Appl. No.: 18/877,036

(22) PCT Filed: Jun. 29, 2023
(86) PCT No.: PCT/EP2023/067861

§ 371 Date: Dec. 19, 2024

(30) Foreign Application Priority Data
Jun. 29, 2022 (DE) 10 2022 116 208.7

(51) Int. Cl. H02K 5/20; B60K 1/00; H02K 9/19

(52) U.S. Cl. CPC H02K 5/203; B60K 1/00; H02K 9/19

(57) ABSTRACT

The invention relates to a drive unit for a motor vehicle, comprising a machine having a rotor, which has a shaft, and which can be rotated about an axis of rotation relative to at least one component of the machine, and comprising a diverting device designed for diverting electrical currents from the rotor, which has a contact element that can be moved relative to the component and is electrically connected to the component, which in turn has a first sliding contact surface in contact with a second sliding contact surface of the shaft that can be rotated about the axis of rotation relative to the contact element, whereby an electrically conductive sliding contact is formed between the sliding contact surfaces, via which the electrical currents can be transmitted from the rotor, via the contact element, to the component, and can thus be diverted from the rotor.

### CROSS-REFERENCE TO RELATED APPLICATIONS

This application is a U.S. national phase application filed under 35 U.S.C. § 371 of International Application Number PCT/EP2023/067861, filed Jun. 29, 2023, designating the United States, which claims priority from German Application Number DE 10 2022 116 208.7, filed Jun. 29, 2022, which are both hereby incorporated herein by reference in their entirety.

### FIELD

The invention relates to a drive unit for a motor vehicle, in particular for a car, according to the preamble of claim 1. Furthermore, the invention relates to a motor vehicle, in particular a car, with at least one such drive unit.

### BACKGROUND

WO 2019/185 447 A1 discloses a diverting device for diverting electrical currents from a rotor part of a machine, which is designed in particular with a shaft, in a stator part of the machine. Furthermore, DE 10 2010 039 847 A1 discloses a grounding contact.

The object of the present invention is to create a drive unit for a motor vehicle and a motor vehicle with at least one such drive unit, such that, on the one hand, a particularly advantageous diverting of electrical currents and, on the other hand, an advantageous cooling and/or lubrication of the machine can be realized.

### SUMMARY

According to the invention, this object is achieved by a drive unit having the features of claim 1 and by a motor vehicle having the features of claim 10. Advantageous embodiments of the invention are the subject matter of the dependent claims.

A first aspect of the invention relates to a drive unit for a motor vehicle. This means that the motor vehicle, preferably designed as a car, in particular as a passenger car, and simply also referred to as a vehicle, has the drive unit in its completely manufactured state and can be driven by means of the drive unit. The drive unit has a machine by means of which the motor vehicle can be driven. Preferably, the machine is an electric machine that can be operated, for example, in motor mode and thus as an electric motor, by means of which the motor vehicle can be driven, in particular purely, electrically.

The motor vehicle is therefore preferably designed as a hybrid or electric vehicle, in particular as a battery electric vehicle (BEV). Quite preferably, the electrical machine is a high-voltage component whose electrical voltage, in particular electrical operating or rated voltage, is preferably greater than 50 volts and quite preferably several hundred volts. The machine has a rotor, which is also referred to as a rotor part or rotor unit. Furthermore, the machine has at least one component provided in addition to the rotor, wherein the rotor is rotatable about an axis of rotation relative to the at least one component. In particular, the machine can provide torque via its rotor to drive the motor vehicle. The rotor has a shaft which can thus be rotated about the axis of rotation relative to the at least one component. In particular, the machine can provide the aforementioned torques via the shaft, by means of which the motor vehicle can be driven. Thus, for example, the shaft is a drive shaft of the machine, in particular of the drive unit as a whole. It is thus conceivable in particular that the drive unit as a whole can provide drive torques via the rotor, in particular via the shaft, for driving the motor vehicle, in particular purely electrically, wherein the drive torques can result from the aforementioned torques or wherein the drive torques can correspond to the torques.

The drive unit also has a diverting device by means of which electrical currents can be diverted from the rotor, i.e. from the rotor and in particular from the shaft. This is to be understood in particular as meaning that the electrical currents can be transmitted from the rotor, in particular from the shaft, to the diverting device and can thus be discharged or dissipated from or by the rotor, in particular from or by the shaft. This allows the electrical currents to be discharged from the rotor in a targeted manner, i.e. without causing undesirable damage to the drive unit, for example, in particular as a result of the electrical currents being discharged from the rotor in an untargeted or accidental manner. In particular, it is conceivable that the machine, particularly the electric machine, has a stator by means of which, for example, the rotor can be driven, particularly using electrical energy, and can thus be rotated about the axis of rotation relative to the stator. For example, the at least one component can be a component part of the stator. The rotor and thus the shaft are rotatable about the axis of rotation relative to the at least one component.

The diverting device has a contact element which can be displaced relative to the component, in particular along a sliding direction, and which is at least indirectly, in particular directly, electrically connected to the component, i.e. electrically contacted. The contact element has a first sliding contact surface which bears against a second sliding contact surface of the shaft. The shaft can be rotated about the axis of rotation relative to the contact element, so that when the shaft is rotated about the axis of rotation relative to the component and also relative to the contact element while the sliding contact surfaces are in contact with one another, in particular directly, the sliding contact surfaces slide or grind against one another.

The fact that the sliding contact surfaces are in contact with one another, in particular directly, means that an electrically conductive sliding contact is formed between the sliding contact surfaces, via which the electrical currents can be transmitted from the shaft and thus from the rotor via the contact element to the component and can thus be discharged from the rotor, in particular in a targeted manner.

The diverting device also has, for example, at least one spring element, which is preferably formed separately from the contact element and/or separately from the component. The first sliding contact surface is pretensioned against the second sliding contact surface by means of the spring element, particularly along the sliding direction. For example, the spring element is tensioned for this purpose, whereby the spring element provides a spring force that acts in particular along the sliding direction. By means of the spring force, the first sliding contact surface is held in contact, in particular direct contact, with the second sliding contact surface, as a result of which the first sliding contact surface is preloaded, in particular directly, against the second sliding contact surface. The spring element is preferably elastically deformable, particularly along the sliding direction. The axis of rotation runs in the axial direction of the shaft, in particular in such a manner that the axis of rotation coincides with the axial direction of the shaft. For example, the sliding direction runs parallel to the axial direction of the shaft and therefore parallel to the axis of rotation. Thus, for example, the spring element allows axial movements, i.e. translational movements of the contact element along the sliding direction and relative to the component. Such translational movements of the contact element along the sliding direction and relative to the component are caused, for example, by axial movements of the shaft. The axial movements of the shaft are understood to be translational movements of the shaft in the axial direction of the shaft and relative to the component. If the shaft thus moves in the axial direction of the shaft relative to the component, the contact element is moved in translation along the sliding direction relative to the component during such axial movements of the shaft, for example, wherein the switching contact surfaces are in contact with one another, in particular directly, when viewed in the axial direction of the shaft or along the sliding direction, wherein the first sliding contact surface is held in contact, in particular direct contact, with the second sliding contact surface by means of the spring element during these axial movements of the shaft and during these axial movements of the contact element. In other words, the contact element can thus also execute the axial movements of the shaft, while the first sliding contact surface is kept in contact, in particular direct contact, with the second sliding contact surface by means of the spring element.

In order, on the one hand, to be able to divert the electrical currents particularly advantageously from the rotor and, in particular, to be able to introduce them into the component via the contact element and, on the other hand, to be able to realize a particularly advantageous lubrication and/or cooling of the machine, it is provided according to the invention that a structural part of the shaft forming the second sliding contact surface has a central through-opening with respect to the axis of rotation and the shaft, which opens into a hollow, first longitudinal region of the shaft on a side of the structural part facing away from the first sliding contact surface, in particular in the axial direction of the shaft.

The at least one component of the machine is also referred to as the first component or first structural part, wherein, for example, the component having the passage opening is also referred to as the second component or second structural part. The shaft is therefore hollow, at least in the first length range, and is therefore designed as a hollow shaft. When the component or at least one component is referred to in the following, this is to be understood as the first component, i.e. the first structural part. When referring to the structural part in the following, this is understood to mean the second component or the second structural part.

Furthermore, it is provided according to the invention that the second sliding contact surface and thus also the first sliding contact surface are arranged off-axis to the axis of rotation. In other words, the second sliding contact surface and thus also the first sliding contact surface are off-axis with respect to the axis of rotation. This means that the second sliding contact surface and thus also the first sliding contact surface are offset outwards in relation to the axis of rotation, particularly when viewed in the radial direction of the shaft.

Furthermore, according to the invention, it is provided that the component has a fluid channel through which a preferably liquid lubricant and/or coolant can flow. The lubricant and/or coolant is a fluid, in particular a liquid, so that when the fluid is referred to in the following, it is understood to mean the lubricant and/or coolant, unless otherwise specified. At least in a second longitudinal region of the fluid channel, the fluid channel has a direction of passage that runs at an angle to the axis of rotation and thus at an angle to the axial direction of the shaft, in which the fluid (lubricant and/or coolant) can flow through the second longitudinal region. This means that during operation of the drive unit and thus the machines, the fluid (lubricant and/or coolant) flows through the second length area in the direction of passage. The direction of passage in which the fluid flows through the second longitudinal region of the fluid channel during the aforementioned operation is also referred to as the first direction of passage of the second longitudinal region of the fluid channel.

The second length region opens in the direction of passage into an environment of the component via an outlet opening of the second length region arranged on a side of the component facing the second sliding contact surface, in particular in the axial direction of the shaft, whereby the lubricant and/or coolant (fluid) flowing through the second length region in the direction of passage of the second length region can be sprayed out of the second length region and thus out of the fluid channel in the direction of passage via the outlet opening, can be sprayed through the passage opening in the direction of passage of the second length region and can be injected into the hollow, first length region of the shaft in the direction of passage of the second length region. This allows the fluid to be introduced particularly advantageously into the hollow, first longitudinal region of the shaft, in particular in such a manner that an inner circumferential surface of the shaft can be particularly advantageously wetted or sprayed with the fluid. This includes the following in particular: The hollow, first length region is, for example, a particularly central channel or has a particularly central channel, wherein the channel is bounded, particularly directly, by the inner circumferential lateral surface of the shaft, particularly in the radial direction of the shaft towards the outside. Due to the particularly advantageous wetting of the inner circumferential surface of the shaft with the fluid, a particularly advantageous swirl of the fluid in the hollow, first longitudinal region can be achieved, for example in the aforementioned operation, in particular by the fact that the fluid with which the inner circumferential surface of the shaft is or was wetted is carried along by the inner circumferential surface of the shaft rotating about the axis of rotation. This causes the fluid in the hollow, first length range to swirl. As a result, the fluid can be conveyed through the hollow, first longitudinal region in a particularly advantageous manner, particularly along the axial direction of the shaft, so that points of the machine to be supplied with the fluid can be supplied particularly well with the fluid, particularly with a sufficiently large quantity of the fluid. By de-axializing the sliding contact surfaces in relation to the axis of rotation, it is possible to arrange the through-opening centrally in relation to the axis of rotation, so that an advantageously large amount of fluid can be injected through the through-opening and thus into the hollow, first longitudinal region. This advantageously large quantity of fluid can be conveyed particularly advantageously to the aforementioned points by the advantageous effecting of the swirl of the fluid in the hollow, first length region described above, so that particularly advantageous lubrication and/or cooling of the machine can be ensured.

Tests have shown that a central arrangement of the sliding contact surfaces in relation to the axis of rotation and a resulting off-axis arrangement of the through-opening in relation to the axis of rotation can lead to an aperture effect on the one hand, so that a sufficiently large amount of fluid cannot be introduced into the hollow, first length range. On the other hand, advantageous wetting of the inner circumferential surface of the shaft with the fluid may no longer be possible, so that no swirl or only an unfavorably low swirl can be imparted to the fluid in the hollow, first length range. As a result, it may not be possible to guarantee the desired supply of fluid to the areas. However, the invention now makes it possible to advantageously supply the points with an advantageously large quantity of the fluid, so that particularly advantageous lubrication and/or cooling of the machine can be ensured.

In order to be able to realize a particularly advantageous supply of the point with the fluid, it is provided in one embodiment of the invention that the fluid channel has a third longitudinal region, which is arranged upstream of the second longitudinal region as viewed along the first direction of passage and whose direction of passage, also referred to as the second direction of passage, in which the lubricant and/or coolant can flow through the third longitudinal region, runs obliquely to the direction of passage of the second longitudinal region and parallel to the axis of rotation, thus parallel to the axial direction of the shaft. This allows a particularly large amount of fluid to be injected into the hollow, first length region in an advantageously short time.

It has been shown to be particularly advantageous if the second longitudinal region is directly connected to the third longitudinal region, which is fluidically connected to the second longitudinal region, so that no other, further longitudinal region of the fluid channel is arranged between the second longitudinal region and the third longitudinal region when viewed along the respective direction of passage. This allows a particularly large amount of the fluid to flow through the second length region and through the third length region and through the third length region, i.e. through the fluid channel, and subsequently be injected into the hollow, first length region, so that a particularly advantageous supply of the fluid to the points can be ensured.

A further embodiment is characterized by the fact that the through-opening is circular and thus in the form of a circle, the center of which lies on the axis of rotation. As a result, the fluid can be introduced, in particular injected, into the hollow, first longitudinal region in a particularly advantageous manner, so that the inner circumferential surface of the shaft can be wetted with the fluid in a particularly advantageous manner. As a result, an advantageous delivery of the fluid in or through the hollow, first length region can be ensured, so that the points can be particularly well supplied with the fluid.

In order to be able to ensure particularly advantageous lubrication and/or cooling of the machine, it is provided in a further embodiment of the invention that the outlet openings are circular and thus in the form of a circle, the center of which can lie on the axis of rotation or, in particular, be spaced from the axis of rotation in the radial direction of the shaft. In particular, it is conceivable that the axis of rotation intersects the outlet opening. Preferably, it is provided that the outlet opening and the through-opening overlap one another when viewed in the axial direction of the shaft, in particular in such a manner that preferably the outlet opening is at least predominantly, i.e. at least more than half or completely, overlapped by the through-opening when viewed in the axial direction of the shaft and in particular towards the hollow, first length region. This allows a particularly large amount of fluid to be injected into the first length range.

For example, the outlet opening and the through-opening extend in planes that are parallel to one another and, for example, spaced apart or coincide, preferably perpendicular to the axial direction of the shaft, i.e. perpendicular to the axis of rotation.

In order to arrange the through-opening in a particularly advantageous manner and thus to be able to introduce, in particular inject, the fluid into the hollow first longitudinal region in a particularly advantageous manner, it is provided in a further embodiment of the invention that the axis of rotation is at a distance from the entire first sliding contact surface, i.e. does not intersect the first sliding contact surface.

Preferably, it is provided that the sliding contact surfaces run in a common sliding contact surface plane, which preferably runs perpendicular to the axis of rotation of the shaft and perpendicular to the axial direction of the shaft, in particular because the sliding contact surfaces are in direct contact with one another.

In order to be able to divert the electrical currents from the rotor in a particularly advantageous and targeted manner and to ensure a particularly advantageous supply of the fluid to the points, it is provided in a further embodiment of the invention that the structural part forming the second sliding contact surface is a cap which is formed separately from a shaft body of the shaft and is connected in a rotationally fixed manner to the shaft body, which has the hollow, first longitudinal region and thus in particular the inner circumferential lateral surface of the shaft.

In order to be able to divert the electrical currents in a particularly advantageous and targeted manner on the rotor via the shaft, it is provided in a further embodiment of the invention that the shaft is designed as an intermediate shaft. The rotor has a rotor shaft arranged coaxially to the intermediate shaft, which is separate from the intermediate shaft and is connected to the intermediate shaft in a rotationally fixed manner.

For example, the rotor shaft is arranged at least partially in a laminated core of the rotor, in particular in such a manner that the laminated core is non-rotatably connected to the rotor shaft. It is conceivable that the intermediate shaft is not arranged in the laminated core, but is completely connected to the laminated core in the axial direction of the intermediate shaft and thus in the axial direction of the rotor shaft.

A further embodiment is characterized by the fact that, in relation to a torque flow, also referred to as a torque path, along which torques can be transmitted from the rotor shaft arranged in the torque flow to the intermediate shaft arranged in the torque flow, the rotor shaft is arranged upstream of the intermediate shaft, and thus the intermediate shaft is arranged downstream of the rotor shaft. This allows the electrical currents to be discharged from the rotor via the rotor shaft and the intermediate shaft in a particularly advantageous and targeted manner without causing undesirable damage to the inlet unit.

In particular, the diverting device is or functions as a grounding device via which the shaft and thus the rotor can be grounded, i.e. connected to an electrical ground. In particular, the diverting device is a wet-running diverting device, and by this it is to be understood in particular that, in particular during the aforementioned operation of the inlet unit and thus of the machine, the diverting device is arranged at least partially in the fluid, which is preferably designed as a liquid, in particular as oil. In the invention, the diverting device performs a particularly advantageous fluid lance function, in particular an oil lance function, in the context of which the fluid, for example in the form of oil, can be injected in a particularly advantageous, targeted manner and in a sufficiently large quantity via the through-opening in the hollow, first length region. Via the hollow, first length region, for example, bearing points as well as the rotor and, for example, also the stator can be supplied with the fluid and thereby cooled and/or lubricated, which is ejected from the outlet opening and thereby injected through the through-opening at an angle to the axis of rotation and thus into the high, first length region.

For example, the second length region and/or the third length region is formed as a respective bore or is formed by a bore. The fact that the direction of passage of the second longitudinal region runs at an angle to the axial direction of the shaft, i.e. at an angle to the axis of rotation, can ensure a particularly advantageous wall contact of the fluid flowing through the through-opening, and thus of a fluid jet formed by the fluid flowing through the through-opening, with the circumferential surface of the shaft on the inside, also known as the inner wall or formed by an inner wall. A resulting swirl, in particular of the fluid, transports the fluid, in particular automatically, through the hollow, first length range and into an interior of the rotor. Simulations have confirmed a particularly high effectiveness of the invention, in particular with regard to an advantageous transportation of the fluid through the hollow, first length region to the aforementioned points and in particular with an advantageously large quantity.

A second aspect of the invention relates to a motor vehicle preferably designed as a car, in particular a passenger car, and also referred to as a vehicle, which has at least one drive unit according to the first aspect of the invention. Advantages and advantageous embodiments of the first aspect of the invention are to be regarded as advantages and advantageous embodiments of the second aspect of the invention and vice versa.

### BRIEF DESCRIPTION OF THE DRAWINGS

Further details of the invention are provided in the following description of a preferred embodiment with the associated drawings. In the figures:

FIG. 1 shows a schematic and perspective sectional view of a drive unit for a motor vehicle;

FIG. 2 shows a further schematic and perspective sectional view of the drive unit; and

FIG. 3 shows a schematic perspective view of a diverting device of the drive unit.

In the figures, identical or functionally identical elements are marked with the same reference symbol.

### DETAILED DESCRIPTION

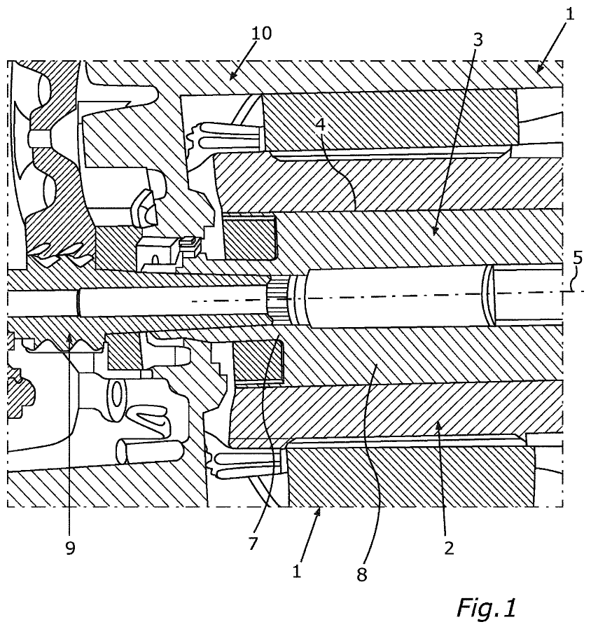

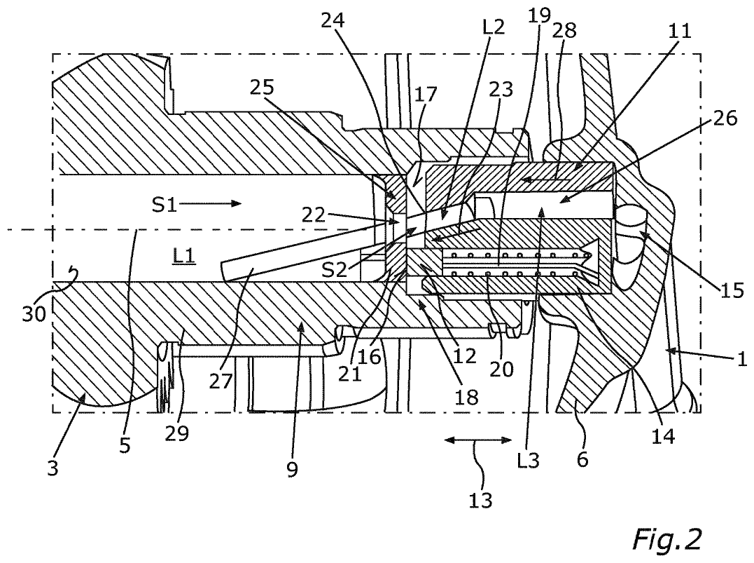

FIG. 1 shows a schematic and sectional perspective view of a drive unit 1 for a motor vehicle, also simply referred to as a vehicle and preferably designed as a car, in particular as a passenger car, which can be driven by means of the drive unit 1, in particular purely electrically. The drive unit 1 has a machine designed as an electric machine 2, which has a rotor 3 and a stator 4. The rotor 3 can be driven by means of the stator 4 and can thus be rotated about an axis of rotation 5 relative to at least one component 6 (FIG. 2) of the drive unit 1. The rotor 3 has a rotor shaft 7 as the first shaft, wherein the electric machine 2 can provide drive torques via the rotor 3, in particular via the rotor shaft 7, for driving the motor vehicle, in particular purely electrically. For example, the rotor 3 comprises a laminated core 8, wherein the rotor shaft 7 is at least partially arranged in the laminated core 8. In particular, the laminated core 8 is non-rotatably connected to the rotor shaft 7.

The drive unit 1 also comprises an intermediate shaft 9 as a second shaft. The intermediate shaft 9 is separate from the rotor shaft and is connected to the rotor shaft 7 so that it cannot rotate, in particular via a plug-in toothing. As a result, the drive torques provided or that can be provided by the electric machine 2 via its rotor 3, in particular via the rotor shaft 7, can be transmitted to the intermediate shaft 9, which can subsequently provide torques for driving the motor vehicle, in particular purely electrically. The torques are, for example, the drive torques or result from the drive torques. For example, the intermediate shaft 9 is a transmission input shaft or is non-rotatably connected to a transmission input shaft, wherein the aforementioned torques can be introduced into a transmission of the drive unit 1, which is not shown in detail in the figures, via the transmission input shaft. Thus, for example, the motor vehicle can be driven via the transmission by means of the drive unit 1, in particular purely electrically. The drive unit 1 comprises a housing 10, wherein the electric machine 2 and/or the intermediate shaft 9 are each arranged at least partially in the housing 10. The component 6 is a first component, which in the embodiment example shown in the figures is designed as a cover of the housing 10. For example, the housing 10 has a housing element which has a through-opening. For example, the through-opening of the housing element is closed by means of the component 6 (cover).

FIG. 2 shows that the drive unit 1 has a diverting device 11 by means of which electrical currents can be diverted from the rotor 3, in particular via the intermediate shaft 9, in particular into the housing 10 or the component 6. This means in particular that the aforementioned electrical currents can, for example, be transmitted from the rotor 3 via the rotor shaft 7 to the intermediate shaft 9 and from the intermediate shaft 9 to the diverting device 11 and via the diverting device 11 or from the diverting device 11 to the component 6 and can thus be specifically diverted, discharged or dissipated from the rotor 3, in particular without the electrical currents being arbitrarily or randomly diverted from the rotor 3. For example, the rotor 3 is rotatably mounted on the housing 10 about the axis of rotation 5 relative to the housing 10 via at least one or more bearings, for example in the form of roller bearings. In particular, the use of an inverter for the electrical machine 2 can lead to the electrical currents mentioned. If, for example, the diverting device 11 were not used to divert the electrical currents specifically out of or from the rotor 3 of the electrical machine 2, it could happen that the electrical currents, which seek the path of least resistance, jump from the rotor 3 to the housing 10 via the bearing or bearings. This can result in damage to the bearings, in particular to the bearing raceways, which would constitute undesirable damage to the drive unit 1. This can now be ensured by using the diverting device 11.

In order to be able to divert the electrical currents particularly advantageously from the rotor 3 and to ensure particularly advantageous lubrication and/or cooling of the drive unit 1, in particular the electrical machine 2, the diverting device 11 has a contact element 12, which can be displaced relative to the component 6, in particular along a sliding direction illustrated by a double arrow 13 in FIG. 2. In the embodiment example shown in Fig., the diverting device 11 has a second component 14 which is formed separately from the first component 6 and which functions or is formed as a guide element, for example, by means of which the contact element 12 is guided along the sliding direction. The contact element 12 can thus be moved along the component 14 and along the sliding direction, i.e. it can be moved back and forth in a guided manner.

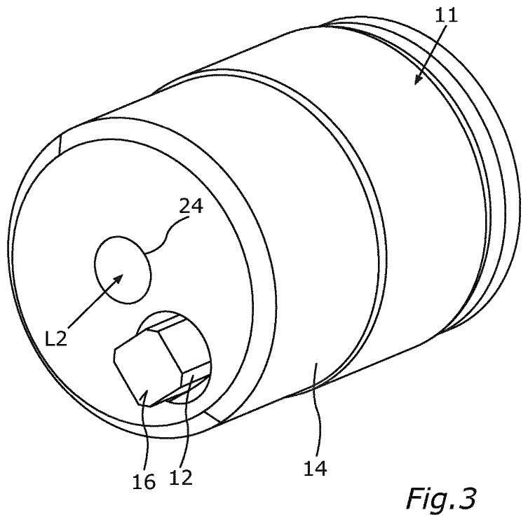

In particular, in the embodiment example shown in Fig. the component 14 is a housing of the diverting device 11. The component 14 is separate from the component 6. In addition, the component 14 is electrically connected by the component 6, i.e. electrically contacted with the component 6, in particular directly. In particular, the component 14 is connected to the component 6, in particular in such a manner that relative rotations and preferably also transitory relative movements between the components 14 and 6 are avoided. For example, the component 14 is pressed into the component 6. The diverting device 11 is shown in FIG. 3 in a schematic perspective view.

It can be seen from FIG. 2 that the component 6 has a channel 15, still referred to as the main channel or main oil channel, through which a lubricant and/or coolant can flow for lubricating and/or cooling the drive unit 1. In the embodiment example shown in Fig., the lubricant and/or coolant, which is also simply referred to as a fluid, is a liquid, in particular an oil, so that the channel 15 is also referred to as an oil channel or main oil channel. The fluid can be used to lubricate and/or cool at least certain points of the drive unit 1. Some of the points are, for example, bearing points that are supplied with the fluid and can therefore be lubricated and/or cooled by means of the fluid.

In particular, the aforementioned bearings are arranged at the bearing points.

For example, the bearings are roller bearings.

It can be seen particularly clearly from FIGS. 2 and 3 that the contact element 12, in particular on its end face facing the intermediate shaft 9, in particular in the axial direction of the intermediate shaft 9, has a first sliding contact surface 16, which is also referred to as the first contact surface. The first sliding contact surface 16 is in contact, in particular directly, with a second sliding contact surface 17 of the intermediate shaft 9, whereby an electrically conductive sliding contact 18 is formed between the sliding contact surfaces 16 and 17. The second sliding contact surface 17 is also referred to as the second sliding contact surface. Via the electrically conductive sliding contact 18, the aforementioned electrical currents can be transmitted from the rotor 3 via the contact element 12 to the component 14 and via the latter to the component 6, thereby being discharged from the rotor 3. In other words, the electrical currents can, for example, be transmitted from the rotor 3 via the rotor shaft 7 to the intermediate shaft 9 and from the intermediate shaft 9 via the sliding contact 18 to the contact element 12 and from the contact element 12 to the component 14 and from the component 14 to the component 6. For this purpose, for example, the contact element 12 is electrically connected to the component 14 via a, in particular electrically conductive, stranded wire 19 of the diverting device 11, in particular in such a manner that the stranded wire 19 is electrically conductively connected to the contact element 12 at one end, in particular at one end, and electrically conductively connected to the component 14 at the other end, in particular at the other end. At least a partial area of the wire 19 carries out the displacements of the contact element 12 relative to the component 14 and relative to the component 6. The diverting device 11 also comprises a spring element 20, which in the present case is designed as a mechanical spring, in particular as a compression spring. The first sliding contact surface 16 is pretensioned against the second sliding contact surface 17 by means of the spring element 20. For example, the spring element 20 is tensioned for this purpose, whereby the spring element 20 provides a spring force that acts in particular along the sliding direction. The spring force keeps the sliding contact surface 16 in contact, particularly direct contact, with the sliding contact surface 17. The spring element 20 can be shaped more elastically along the sliding direction, so that the spring element 20 allows the contact element 12 to be displaced along the sliding direction and relative to the component 14 and relative to the component 6. These displacements of the contact element 12 are also referred to as axial movements of the contact element 12. These axial movements of the contact element 12 occur in particular due to axial movements of the intermediate shaft 9, which, for example, moves translationally, in particular back and forth, in the axial direction of the intermediate shaft 9 and thus along the axis of rotation 5 relative to the housing 10 and thus in particular relative to the components 6 and 14 during the axial movements of the intermediate shaft 9.

A structural part 21 of the intermediate shaft 9 forming the second sliding contact surface 17 has a central through-opening 22 with respect to the axis of rotation 5, which opens into a hollow, first longitudinal region L1 of the intermediate shaft 9 on a side S1 of the structural part 21 facing away from the first sliding contact surface 16, in particular in the axial direction of the intermediate shaft 9. The structural part 21 is also referred to as the first component or first structural part. The second sliding contact surface 17 is arranged off-axis to the axis of rotation 5, in particular in such a manner that the axis of rotation 5 does not intersect the sliding contact surfaces 16 and 17. Thus, for example, the second sliding contact surface 17 is ring-shaped and thus designed as a ring, the center of which lies on the axis of rotation 5, for example. The component 6 is also referred to as the first component or first structural part, the component 14 is also referred to as the second component or second structural part, the structural part 21 is also referred to as the third structural part or third component.

The component 14 has a fluid channel 26 through which the fluid can flow and which is fluidically connected to the channel 15. This allows the fluid flowing through the channel 15 to flow from the channel 15 into the fluid channel 26. The fluid channel 26 has a second longitudinal region L2, the direction of passage of which is illustrated by an arrow 23 and runs at an angle to the axis of rotation 5. The fluid can flow through the second longitudinal region L2 of the fluid channel 26 in the direction of passage, also referred to as the first direction of passage and illustrated by the arrow 23. In addition, the second longitudinal region L2 and thus the fluid channel 26 as a whole opens in the first direction of passage via an outlet opening 24 of the second longitudinal region L2 arranged on a side S2 of the component 14 facing the second sliding contact surfaces 17 into an environment 25 of the structural part 4, in the environment 25 of which the component 21 is arranged in the present case.

As a result, it is possible for the fluid flowing through the second longitudinal region L2 in the first direction of passage illustrated by the arrow 23 to be sprayed out of the second longitudinal region L2 and out of the fluid channel 26 as a whole via the outlet opening 24 to be sprayed at or into the surroundings 25, to be sprayed through-opening 22 and to be injected into the hollow first longitudinal region L1 of the intermediate shaft 9. In other words, during operation of the drive unit 1, the fluid first flows through the channel 15. The fluid flows from the channel 15 into and through the fluid channel 26 and thus through the second longitudinal region L2, wherein the fluid flows in the first direction of passage illustrated by the arrow 23 through the second longitudinal region L2 and thereby through the outlet opening 24. The outlet opening 24 is a purely two-dimensional opening or can be imagined as a two-dimensional opening, via which the second longitudinal region L2 and thus the fluid channel 26 opens into the environment 25. During operation, the fluid is thus ejected in the first direction of passage illustrated by the arrow 23 via the outlet opening 24 from the second length region L2 and thus from the fluid channel 26, and the fluid is injected through the through-opening 22 in the first direction of passage illustrated by the arrow 23, and the fluid is injected into the hollow first length region L1 in the first direction of passage illustrated by the arrow 23. In FIG. 2, a fluid jet, also known simply as a jet, is shown schematically and labeled 27. The fluid jet 27 is formed by the fluid which is ejected in the first direction of passage, illustrated by the arrow 23, via the outlet opening 24 from the second length region L2 and through-opening 22. Since the fluid is preferably an oil, the fluid jet 27 is preferably an oil jet. It can be seen that the intermediate shaft 9 in the first length region L1 has an inner circumferential lateral surface 30 against which the fluid jet 27 and thus the fluid forming the fluid jet 27 is sprayed, in particular directly, in particular in the first direction of passage illustrated by the arrow 23. If the intermediate shaft 9 rotates about the axis of rotation 5, a swirl, i.e. a swirling flow, is imparted to the fluid, which is sprayed against the inner circumferential surface 30. As a result, the fluid is transported through the hollow, first longitudinal region L1 and, in particular, transported to the aforementioned points, which can be supplied with the fluid in a particularly advantageous manner. This can ensure advantageous cooling and/or lubrication of the drive unit 1, in particular the electric machine 2.

It can be seen particularly clearly from FIG. 2 that the fluid channel 26 has a third longitudinal region L3 arranged upstream of the second longitudinal region L2, the second direction of passage of which, illustrated by an arrow 28, runs parallel to the axis of rotation 5. Thus, the second direction of passage (arrow 28) runs at an angle to the first through-opening (arrow 23). The second length region L2 directly adjoins the third length region L3.

In the embodiment example shown in Fig. the through-opening 22 is circular and thus in the form of a circle, the center of which lies on the axis of rotation 5. The outlet opening 24 is also circular and therefore in the shape of a circle, although its center is at a distance from the axis of rotation 5, for example. However, the axis of rotation 5 intersects the outlet opening 24. Furthermore, in the embodiment example, it is provided that the axis of rotation 5 is spaced apart from the entire first sliding contact surface 16.

The structural part 21 forming the second sliding contact surface 17 is a cap, which is formed separately from a shaft body 29 of the intermediate shaft 9. The structural part 21 (cap) is non-rotatably connected to the shaft body 29, wherein the shaft body 29 has the hollow, first longitudinal region L1 and, in particular, the inner circumferential lateral surface 30.

### LIST OF REFERENCE NUMBERS

1 drive unit
2 electric machine
3 rotor
4 stator
5 axis of rotation
6 first component
7 rotor shaft
8 laminated core
9 intermediate shaft
10 housing
11 diverting device
12 contact element
13 double arrow
14 second component
15 channel
16 first sliding contact surface
17 second sliding contact surface
18 electrically conductive sliding contact
19 wire
20 spring element
21 structural part
22 through-opening
23 arrow
24 outlet opening
25 environment
26 fluid channel
27 fluid jet
28 arrow
29 shaft body
30 inner circumferential lateral surface S1 side
S2 page
L1 length region
L2 length region
L3 length region

1. A drive unit for a motor vehicle, comprising a machine having a rotor with a shaft which is rotatable about an axis of rotation relative to at least one component of the machine, and comprising a diverting device which is designed to divert electrical currents from the rotor and which has a contact element which is displaceable relative to the component and electrically connected to the component, which has a first sliding contact surface which bears against a second sliding contact surface of the shaft rotatable about the axis of rotation relative to the contact element, whereby an electrically conductive sliding contact is formed between the sliding contact surfaces, via which the electrical currents can be transmitted from the rotor via the contact element to the component and can thereby be discharged from the rotor,
wherein a structural part of the shaft forming the second sliding contact surface has a central through-opening with respect to the axis of rotation and the shaft, which opens into a hollow, first longitudinal region of the shaft on a side of the structural part facing away from the first sliding contact surface;
the second sliding contact surface is arranged offset outwards relative to the axis of rotation; and
the component has a fluid channel through which a lubricant and/or coolant can flow and which, at least in a second length region of the fluid channel, has a direction of passage which runs at an angle to the axis of rotation and in which:
the lubricant and/or coolant can flow through the second longitudinal region; and
the second length region opens into an environment of the component via an outlet opening of the second length region arranged on a side of the component facing the second sliding contact surface, whereby the lubricant and/or coolant in the direction of passage flowing through the second longitudinal region in the direction of passage can be sprayed out of the second longitudinal region and out of the fluid channel via the outlet opening, can be sprayed through the through-opening and can be injected into the hollow, first longitudinal region of the shaft.

2. The drive unit according to claim 1, wherein
the fluid channel has a third longitudinal region arranged upstream of the second longitudinal region, the direction of passage of which, in which the lubricant and/or coolant can flow through the third longitudinal region, runs at an angle to the direction of passage of the second longitudinal region and parallel to the axis of rotation.

3. The drive unit (1) according to claim 2, wherein
the second length region directly adjoins the third length region.

4. The drive unit according to claim 1, wherein
the through-opening is circular and thus in the form of a circle, the center of which lies on the axis of rotation.

5. The drive unit according to claim 1, wherein
the outlet opening is circular and thus in the shape of a circle.

6. The drive unit according to claim 1, wherein
the axis of rotation is at a distance from the entire first sliding contact surface.

7. The drive unit according to claim 1, wherein
the structural part forming the second sliding contact surface is a cap which is formed separately from a shaft body of the shaft and is connected in a rotationally fixed manner to the shaft body, which has the hollow, first length region.

8. The drive unit (1) according to claim 1, wherein
the shaft is designed as an intermediate shaft, wherein the rotor has a rotor shaft arranged coaxially to the intermediate shaft, which is designed separately from the intermediate shaft and is connected to the intermediate shaft in a rotationally fixed manner.

9. The drive unit according to claim 8, wherein
in relation to a torque flow along which torques can be transmitted from the rotor shaft arranged in the torque flow to the intermediate shaft arranged in the torque flow, the rotor shaft is arranged upstream of the intermediate shaft.

10. A motor vehicle, having at least one drive unit according to claim 1.
